(19) United States
(12) Patent Application Publication
(10) Pub. No.: US 2009/0108543 A1
(43) Pub. Date: Apr. 30, 2009

(54) Sealed exhaust system joint

(75) Inventor: Craig Phillip Hittle, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/980,443

(22) Filed: Oct. 31, 2007

(51) Int. Cl. F02F 11/00

(52) U.S. Cl. 277/591; 123/568.26

(57) ABSTRACT

The present disclosure is directed toward an assembly for an exhaust system. The assembly includes a first exhaust system component having a first mating structure and a second exhaust system component having a second mating structure. The second mating structure is mated with the first mating structure in a manner that allows the second mating structure to move along an axis relative to the first mating structure. Additionally, a first seal is disposed in the interface created between the first exhaust system component and the second exhaust system component.

### TECHNICAL FIELD

The present disclosure relates to joints between exhaust system components and, more particularly, to sealing joints between exhaust system components.

### BACKGROUND

An exhaust system for a power source, such as an engine, may include an exhaust joint between sections of the exhaust system. For example, an exhaust system may include an exhaust manifold with an exhaust joint between sections of the exhaust manifold. The exhaust joint between sections of the exhaust system may contain an exhaust seal. The exhaust seal may fill any space in the exhaust joint in order to prevent exhaust leakage.

A conventional exhaust joint and an exhaust seal, such as a hardened sealant or simple gasket, may not be a practical solution for all applications, especially in high temperature exhaust applications where substantial thermal expansion occurs. Conventional exhaust joints may somewhat constrain relative movement, that is, the components connected by the joint may be unable to freely expand in response to temperature increases. This inability of exhaust components to freely expand when their temperature increases may cause thermal stresses to build up and may eventually lead to exhaust component stress failure. Stresses due to thermal expansion may cause cracking in the exhaust manifold, exhaust joint, or at any point in the exhaust system. Further, stress arising from axial misalignment, cyclic vibration, and mechanical loading may also contribute to failure and crack formation.

U.S. Pat. No. 4,863,200 (the '200 patent) issued to Brandener on Sep. 5, 1989 discloses an exhaust joint comprising a pivot point that provides flexibility between the two exhaust components connected by the joint. The exhaust joint disclosed in the '200 patent employs a fixed sheet metal flange surrounded by a housing that encloses the joint. The housing provides the pivot point of the joint. Further, the housing is welded to one exhaust component and then crimped together around the flange. Two annular metal knit gaskets positioned on opposite sides of the flange provide a seal between the two exhaust system components.

Although the exhaust joint of the '200 patent may have a pivot point that provides flexibility, certain disadvantages persist. The disclosed solution may not accommodate axial misalignment, particularly substantial axial misalignment resulting from thermal expansion. Additionally, since the gaskets are contained inside a housing that is welded and crimped together, maintenance and repair of the joint disclosed in the '200 patent may be difficult, time consuming, and expensive.

The disclosed exhaust joint is directed to overcoming one or more of the problems set forth above.

### SUMMARY

In one aspect, the present disclosure is directed toward an assembly for an exhaust system. The assembly includes a first exhaust system component having a first mating structure and a second exhaust system component having a second mating structure. The second mating structure is mated with the first mating structure in a manner that allows the second mating structure to move along an axis relative to the first mating structure. Additionally, a first seal is disposed in the interface created between the first exhaust system component and the second exhaust system component.

In another aspect, the present disclosure is directed to a method for sealing a portion of an exhaust system. The method includes mating a first structure of a first exhaust system component to a second mating structure of a second exhaust system component, thereby creating an exhaust system joint between the first mating structure and the second mating structure. Further, the method includes impeding leakage of exhaust gas from the exhaust system joint with a first seal disposed in the interface between the first mating structure and the second mating structure. Still further, the method also includes impeding leakage of exhaust gas from the exhaust system joint with a second seal disposed in the interface between the first mating structure and the second mating structure. Finally, the method includes impeding leakage of exhaust gas from the exhaust system joint with sealant disposed between the first seal and the second seal.

### BRIEF DESCRIPTION OF THE DRAWINGS

FIG. 1 is a pictorial representation of an exemplary power system;

FIG. 2 is a pictorial representation of the exemplary exhaust manifold for a power system with an exemplary exhaust system joint; and

FIG. 3 is a perspective view of the exemplary exhaust system joint.

### DETAILED DESCRIPTION

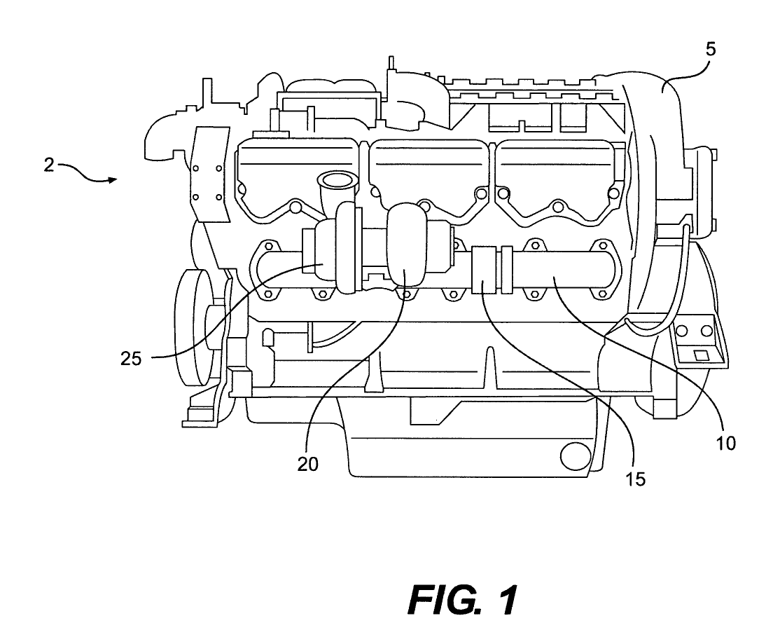

An exemplary embodiment of a power system 2, is illustrated in FIG. 1. The power system 2 may include an engine 5, such as, for example a diesel engine, a gasoline engine, a natural gas engine, or any other engine apparent to one skilled in the art. The power system may further include an exhaust manifold 10 with an exhaust system joint 15, a turbine 20, and a compressor 25. Exhaust manifold 10 may be configured to direct exhaust from an engine to the turbine 20. Turbine 20 may be mechanically connected to drive compressor 25 of an air intake system for the engine 5. It is contemplated that turbine 20 may be omitted and compressor 25 may be driven by the engine 5 mechanically, hydraulically, electrically or in any other manner known in the art. Furthermore, compressor 25 may be omitted entirely.

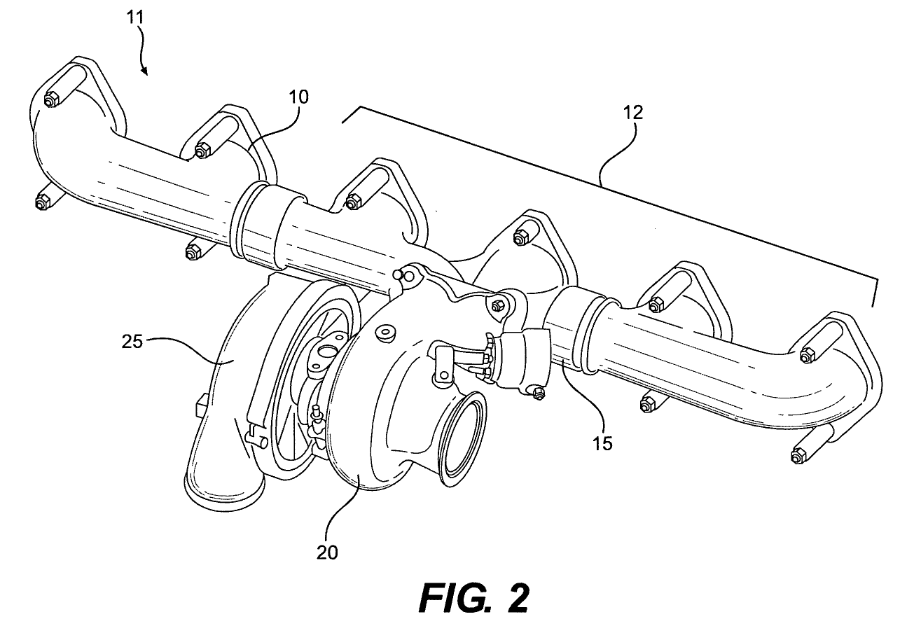

FIG. 2 illustrates a portion of an exhaust system 11 for a power system 2. The portion of the exhaust system 11 shown in FIG. 2 may include an exhaust assembly 12 formed by a first exhaust system component 30 connected by an exhaust system joint 15 to a second exhaust system component 35. As shown in the embodiment of FIG. 2, exhaust assembly 12 of the exhaust system may be a portion of an exhaust manifold 10, or alternatively, may be any other portion of the exhaust system. Exhaust system joint 15 may be a slip joint configured to compensate for axial 14 misalignment. The exhaust system joint 15 may also be configured to compensate for thermal expansion of exhaust system components 30,35.

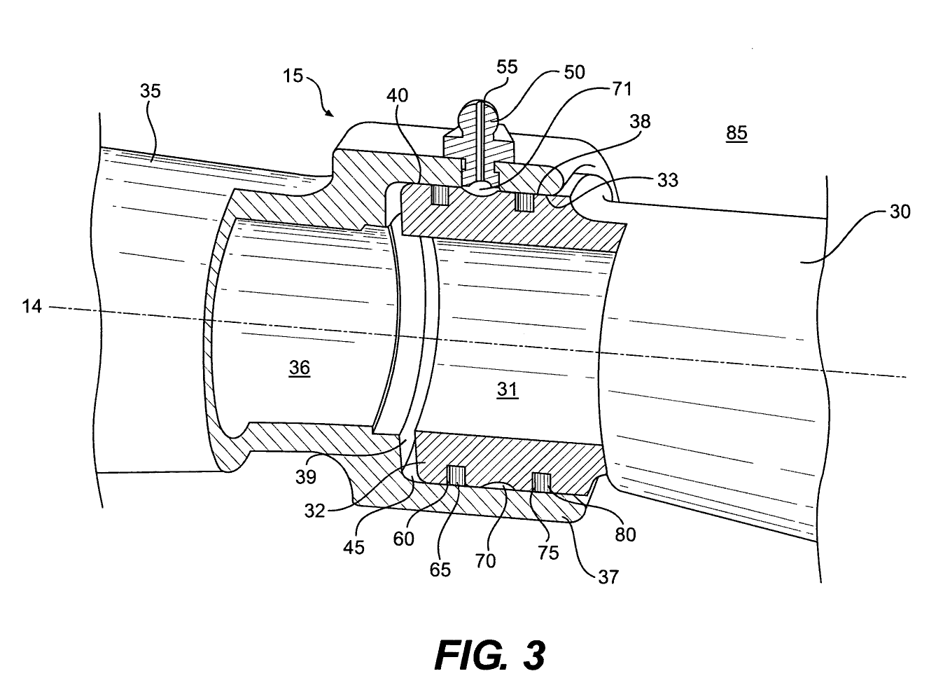

FIG. 3 is a perspective cut away view of the exhaust system joint 15. In the embodiment shown, the exhaust system joint 15 consists of a portion of the first exhaust system component 30 mated to a portion of the second exhaust system component 35. First exhaust system component 30 and second exhaust system component 35 may be, for example, hollow tubular members with substantially circular cross sections. Thus, first exhaust system component 30 may include an interior cavity 31 for conduction of exhaust gasses, and second exhaust system component 35 may include an interior cavity 36 for conduction of exhaust gasses. Internal cavity 31 and internal cavity 36 may connect at exhaust joint 15. It is contemplated that the first exhaust system component 30 and the second exhaust system component 35 may be formed using a sand casting method, an extrusion method, or any other method apparent to one skilled in the art.

The first exhaust system component 30 may further include first mating structure 32. Likewise, the second exhaust system component 35 may include a second mating structure 37. The first mating structure 32 and the second mating structure 37 may include mating surfaces 33,38 that are substantially parallel to the axis 14. The second mating structure may also include a recess 39, and the first mating structure may be disposed, at least partially, into the recess 39. Recess 39, first mating structure 32, second mating structure 37 may all have axes that are substantially parallel to the axis 14.

The position of first mating structure 32 and second mating structure 37 relative to each other may create an axial gap 45. Axial gap 45 may shrink when the first exhaust system component 30 and the second exhaust system component 35 both expand axially 14 in opposite directions as a result of increasing temperature. Additionally, the size of axial gap 45 may depend on the initial position of each exhaust system component 30,35 in the axial 14 direction, which may vary due to manufacturing tolerances and other factors.

At an interface 40 formed between the outside diameter of the first exhaust system component 30 and inside diameter of the second exhaust system component 35 of the embodiment shown in FIG. 3, a first seal 65 and a second seal 80 may each provide a barrier between the internal cavities 31,36 and the ambient environment 85. The first seal 65 and the second seal 80 may be configured to substantially seal the interface 40, thereby blocking fluid inside the internal cavities 31,36 from passing to the outside of exhaust system components 30,35 to the ambient environment 85. The first seal 65 and/or the second seal 80 may be, for example, labyrinth seals. As used herein, a labyrinth seal is any seal that confronts a fluid with a long and arduous path that the fluid must traverse in order to escape past the seal. In one embodiment, the labyrinth seal may include a metallic ring that requires the fluid to traverse each of its windings in order to escape.

The first seal 65 may be disposed in a substantially annular groove 60 and the second seal 80 may be disposed in a similar groove 75. The grooves 60,75 may be features of first exhaust system component 30 and/or second exhaust system component 35, or may be altogether omitted. The seals 65,80 and/or the grooves 60,75 may be saturated with a viscous sealant in order to further seal the exhaust joint 15.

Sealant 71 may be added to the exhaust joint 15. For example, the sealant may be placed in a substantially annular channel 70. It is contemplated that channel 70 may have various configurations, or may be omitted completely. In the embodiment shown in FIG. 3, the channel 70 may be disposed between a first seal 65 and a second seal 80. However, the channel 70 could be disposed at any point on the interface 40 and between the first seal 65 and the second seal 80. The sealant may consist largely of a particulate metal, a copper paste, a graphite powder, a carbon powder, or any other sealant used for its thermal expansion properties and apparent to one skilled in the art. The sealant may be added to exhaust joint 15 in various ways. In some embodiments, the sealant may be added into the channel 70 via a port 55 of a zerk fitting 50 with a grease gun or any other suitable means.

The exhaust assembly 12 of the exhaust system is not limited to the configuration shown in FIG. 2 and FIG. 3. For example, exhaust system components 30,35 may have different shapes than shown in FIG. 2 and FIG. 3. Additionally, one or both of components 30,35 may form part of the exhaust system other than exhaust manifold 10. Indeed, exhaust components 30,35 and exhaust joint 15 may form any part of an exhaust system.

### INDUSTRIAL APPLICABILITY

As described above, the exhaust joint 15 disclosed herein may be applied to any combustion type device, such as, for example, an engine, a furnace, or any other device known in the art where the flow of hot gasses may be directed away from the combustion device. The exhaust joint 15 may be a simple, inexpensive, and durable solution to accommodate thermal expansion, axial misalignment, vibrational loading, and mechanical loading. Additionally, the exhaust joint 15 may enable high temperature and high pressure fluids to be transported away from the combustion device while remaining sealed off from the ambient environment 85.

In the current embodiment, the combustion device may be an engine, such as a twelve cylinder diesel engine. Attached to the engine, the exhaust manifold 10 and the exhaust joint 15 may be configured to collect exhaust gases from the engine and transport the gases to a turbine 20. The running engine may expel hot exhaust gasses from the engine under a pressure. As the gas is forced through the turbine 20, the exhaust gas impinging on the blades (not shown) of the turbine 20 may cause the impeller (not shown) of the turbine 20 to rotate and rotate the mechanically connected impeller (not shown) of the compressor 25. The combined inertia of the impellers of the turbine 20 and the compressor 25 may cause pressure to build in the exhaust manifold 10 and the exhaust joint 15 between the engine 5 and the turbine 20.

A pressure gradient between internal cavities 31,36 and the ambient environment 85 may cause a tendency for the exhaust gas to pass through the axial gap 45 into the interface 40. If the exhaust gas does enter the interface 40, it may encounter the first seal 65. The pressure of the exhaust gas may cause the first seal 65 to press tightly against the wall of first groove 60 and thereby obstruct the flow of exhaust through the interface 40 to the ambient environment 85.

If the exhaust gas escapes past the first seal 65, it may encounter the viscous sealant 71 disposed in channel 70. Thus, the viscous sealant may further restrict the flow of fluid from internal cavities 31,36 to the ambient environment 85. Since the sealant is composed in large part of metallic particles, the sealant may expand as temperatures increase. This may help the sealant maintain an effective seal in the interface 40 when exhaust system components 30,35 undergo thermal expansion and contraction. It is contemplated that the sealant may permeate the first seal 65 and the second seal 80 thereby increasing the effectiveness of the seals 65,80. Exhaust gasses that push past the first seal 65 and the sealant 71 in channel 70 may encounter the second seal 80. Second seal 80 may be disposed within annular groove 75, and may seal the joint 15 in a similar fashion to that of the first seal 65.

During operation, the temperature of the engine 5, exhaust manifold 10, exhaust joint 15, and turbine 20 may increase. Hot exhaust gas from the engine 5, may transfer heat from combustion to the exhaust manifold 10, exhaust joint 15, and the turbine 20. The addition of heat to these components may cause each component to expand. In particular, first exhaust system component 30 and second exhaust system component 35 may expand in both axial 14 and radial directions. Expansion of the first exhaust system component 30 in the axial 14 direction increases its length along the axis 14. Likewise, expansion of the second exhaust system component 35 in the axial 14 direction increases its length along the axis 14 thereby reducing the axial gap 45. It is contemplated that the axial gap 45 may be sized to accommodate the anticipated thermal expansion caused by a standard operating temperature of the engine 5.

Additionally, the exhaust system components 30,35 may also expand in a radial direction, perpendicular to the axis 14 as temperatures increase. Since the first mating structure 32 is in direct contact with the hot exhaust gasses, the first mating structure 32 may expand more than the second mating structure 37 that is in direct contact with the cooler ambient environment 85. This difference in expansion may cause the interface 40 to constrict, thereby increasing the effectiveness of the seals 65,80 and further impeding flow of exhaust from the internal cavities 31,36 to the ambient environment 85.

Several advantages may be realized from the overall design disclosed herein. The disclosed configuration of exhaust joint 15 may allow substantial thermal expansion of the first exhaust system component 30 and the second exhaust system component 35 along their lengths without creating interference between exhaust system components 30,35. Allowing exhaust system components 30,35 to freely expand into axial gap 45 when heated, may reduce the tendency to form cracks due to thermally induced stress. Moreover, a fluid tight seal is maintained during axial and radial thermal expansion.

Another advantage of the design disclosed herein is the ability of the system to accommodate axial misalignment of exhaust system components 30,35. Such axial misalignment may arise, for example, from variations due to manufacturing tolerances. The axial gap 45, may absorb these variations in axial alignment. This ability to compensate for axial misalignment allows for the use of parts that deviate significantly from design dimensions, instead of scrapping them, thereby saving cost.

Still another advantage of the design disclosed herein is the ease of maintenance. After the initial introduction of sealant 71, during the assembly of exhaust joint 15, exhaust joint 15 may occasionally be replenished with sealant by adding additional sealant through port 55 of the zerk fitting 50. Adding sealant routinely may improve the effectiveness of the first seal 65 and the second seal 80.

It will be apparent to those skilled in the art that various modifications and variations can be made to the exhaust joint, without departing from the scope of the disclosure. Other embodiments of the disclosed joint will be apparent to those skilled in the art from consideration of the specification and practice disclosed herein. It is intended that the specification and examples be considered as exemplary only, with a true scope being indicated by the following claims and their equivalents.

What is claimed is:

1. An assembly for an exhaust system, comprising:
a first exhaust system component having a first mating structure;
a second exhaust system component having a second mating structure mated with the first mating structure in a manner allowing the second mating structure to move along an axis relative to the first mating structure; and
a first seal disposed in an interface between the first exhaust system component and the second exhaust system component.

2. The assembly of claim 1, wherein:
the second mating structure includes a recess; and
the first mating structure is disposed at least partially within the recess.

3. The assembly of claim 2, wherein the axis is a central axis of the recess.

4. The assembly of claim 3, wherein the central axis of the first mating structure is substantially concentric to the central axis of the recess.

5. The assembly of claim 2, wherein:
the first mating structure includes a first mating surface extending substantially parallel to a central axis of the recess; and
the second mating structure includes a second mating surface extending substantially parallel to the central axis of the second mating structure and mated with the first mating surface.

6. The assembly of claim 5, wherein sealant is disposed in the interface between the first mating surface and the second mating surface.

7. The assembly of claim 1, wherein the first seal is disposed at least partially within a first groove.

8. The assembly of claim 1, further including a second seal disposed in the interface.

9. The assembly of claim 8, further including sealant disposed between the first seal and the second seal.

10. The assembly of claim 1, further including sealant disposed in the interface.

11. The assembly of claim 1, further including a zerk fitting in fluid communication with the interface.

12. A method of sealing a portion of an exhaust system, comprising:
mating a first mating structure of a first exhaust system component to a second mating structure of a second exhaust system component, thereby creating an exhaust system joint between the first mating structure and the second mating structure;
impeding leakage of exhaust gas from the exhaust system joint with a first seal disposed in an interface between the first mating structure and the second mating structure;
impeding leakage of exhaust gas from the exhaust system joint with a second seal disposed in the interface between the first mating structure and the second mating structure; and
impeding leakage of exhaust gas from the exhaust system joint with sealant disposed between the first seal and the second seal.

13. The method of claim 12, further including allowing the first mating structure and the second mating structure to move relative to one another along an axis.

14. The method of claim 12, wherein:
the first mating structure includes a recess; and
mating the first mating structure to the second mating structure includes supporting the second mating structure at least partially within the recess in a manner allowing the second mating structure to move along an axis relative to the first mating structure.

15. The method of claim 14, wherein the axis is a central axis of the recess.

16. The method of claim 15, further including performing maintenance on the exhaust system joint, including replenishing the interface with additional sealant between the first seal and the second seal.

17. The method of claim 12, wherein replenishing the interface with additional sealant between the first seal and the second seal includes introducing the additional sealant to the interface through a zerk fitting.

18. The method of claim 15, further including maintaining the first seal compressed between the first mating structure and the second mating structure during thermal expansion and contraction of the first mating structure and the second mating structure.

19. A power system, comprising;
a power source;
a portion of an exhaust system connected to the power source in a manner such that the portion of exhaust system conducts exhaust gases discharged by the power source, the portion of exhaust including:
a first exhaust system component having a mating structure that includes a recess;
a second exhaust system component having a second mating structure that mates to the first mating structure by extending at least partially into the recess in a manner allowing the second mating structure to move along an axis relative to the first mating structure; and
a first seal disposed in an interface between the first mating structure and the second mating structure.

20. The power system of claim 19, further including:
a second seal disposed between the first mating structure and the second mating structure; and
sealant disposed between the first seal and the second seal.
